(19) United States
(12) Patent Application Publication
(10) Pub. No.: US 2025/0115222 A1
(43) Pub. Date: Apr. 10, 2025

(54) Trailer Braking Device

(71) Applicant: Matthew Martin, II, Guntersville, AL (US)

(72) Inventor: Matthew Martin, II, Guntersville, AL (US)

(21) Appl. No.: 18/377,185

(22) Filed: Oct. 5, 2023

(51) Int. Cl. B60T 8/24; B60T 8/76

(52) U.S. Cl. CPC B60T 8/248; B60T 8/76; B60T 2240/03; B60Y 2200/147

(57) ABSTRACT

A trailer braking device includes a trailer having an axle, a pair of hubs each rotatably attached to the axle, and a pair of wheels each removably attached to a respective one of the hubs. A plurality of wheel brakes is each integrated into a respective one of the hubs and a pair of wheel speed sensors is each integrated into a respective one of the hubs. A control unit is attached to the trailer and the control unit is in communication with each of the wheel brakes and each of the wheel speed sensors. The control unit actuates a respective one of the wheel brakes when the wheel speed sensor associated with the respective wheel brake communicates that a rotational speed of the hub associated with the respective wheel brake has begun to oscillate. In this way the trailer is inhibited from beginning to sway while being towed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to braking devices and more particularly pertains to a new braking device for inhibiting a trailer from swaying while being towed. The device includes wheel brakes integrated into wheels of a trailer and wheel speed sensors for sensing the rotational speed of the wheels. The device includes a control unit that is in communication with the wheel brakes and the wheel speed sensors and the control unit actuates the wheel brakes when the wheel speed sensors sense oscillation in wheel speed to indicate that the trailer is beginning to sway thereby stabilizing the trailer.

### (2) Description of Related Art Including Information Disclosed Under 37 CFR 1.97 and 1.98

The prior art relates to braking devices including a variety of trailer braking devices that are each designed to minimize or inhibit trailer sway of a trailer while the trailer is being towed which each includes components of the braking system of a tow vehicle. In no instance does the prior art disclose a trailer braking system that includes wheel brakes and wheel speed sensors and which operates independently of the braking system of a tow vehicle.

### BRIEF SUMMARY OF THE INVENTION

An embodiment of the disclosure meets the needs presented above by generally comprising a trailer that has an axle, a pair of hubs each rotatably attached to the axle and a pair of wheels each removably attached to a respective one of the hubs. A plurality of wheel brakes is each integrated into a respective one of the hubs and a pair of wheel speed sensors is each integrated into a respective one of the hubs. A control unit is attached to the trailer and the control unit is in communication with each of the wheel brakes and each of the wheel speed sensors. The control unit actuates a respective one of the wheel brakes when the wheel speed sensor associated with the respective wheel brake communicates that a rotational speed of the hub associated with the respective wheel brake has begun to oscillate. In this way the trailer is inhibited from beginning to sway while being towed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a bottom perspective view of a trailer braking device according to an embodiment of the disclosure.

FIG. 2 is a bottom view of an embodiment of the disclosure.

FIG. 3 is a right side phantom view of an embodiment of the disclosure.

FIG. 4 is a schematic view of an embodiment of the disclosure.

FIG. 5 is a magnified detail view taken from circle 5 of FIG. 3 of an embodiment of the disclosure.

### DETAILED DESCRIPTION OF THE INVENTION

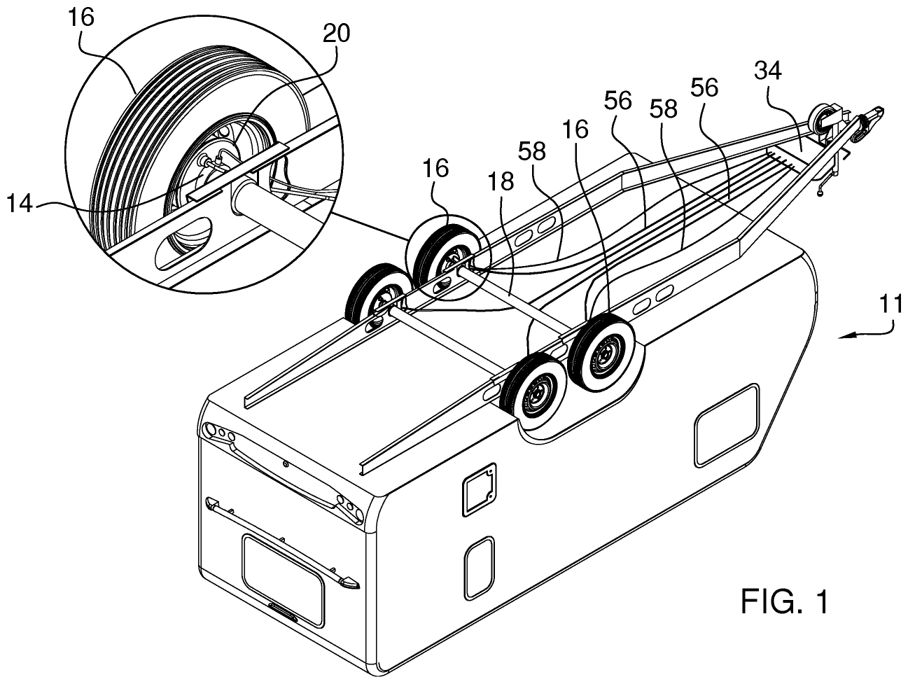

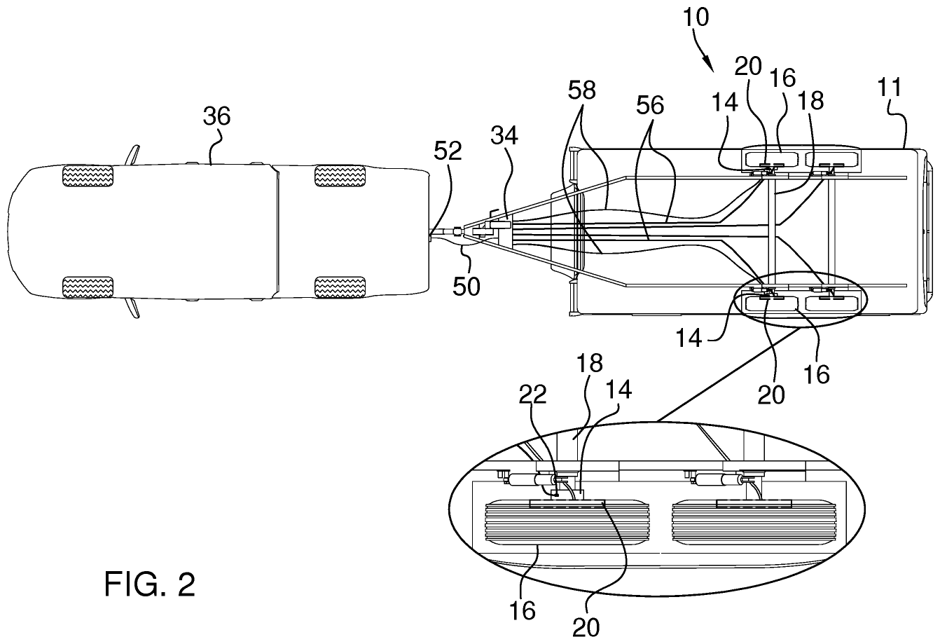

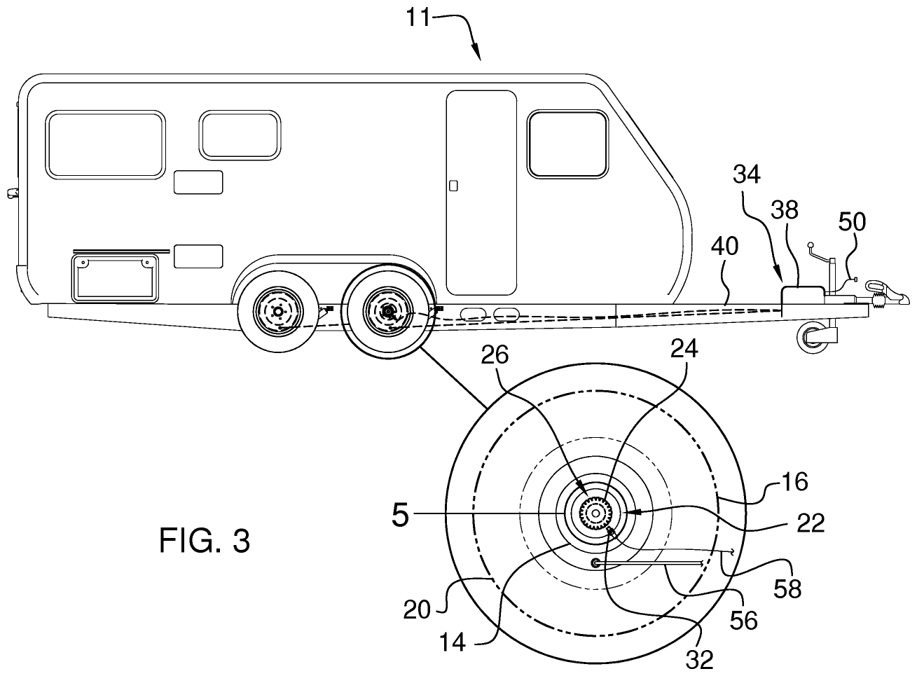

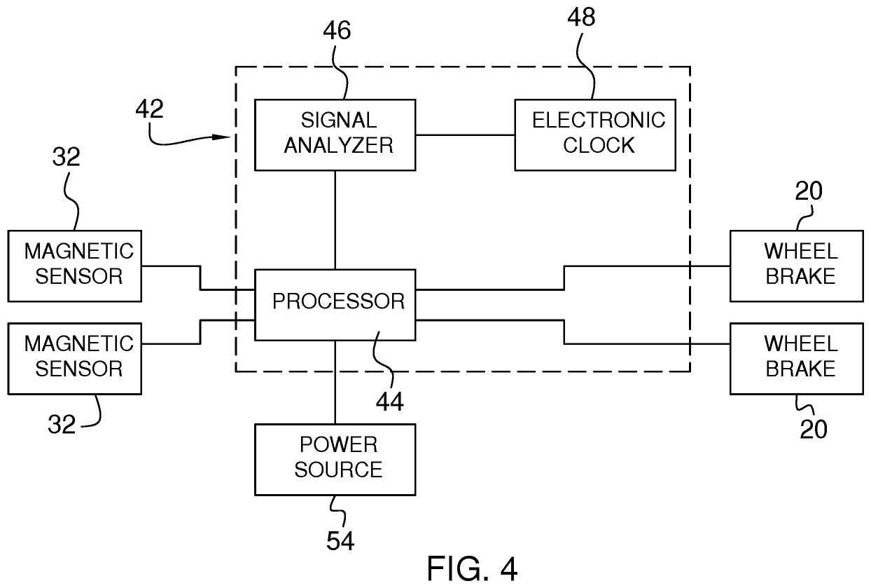

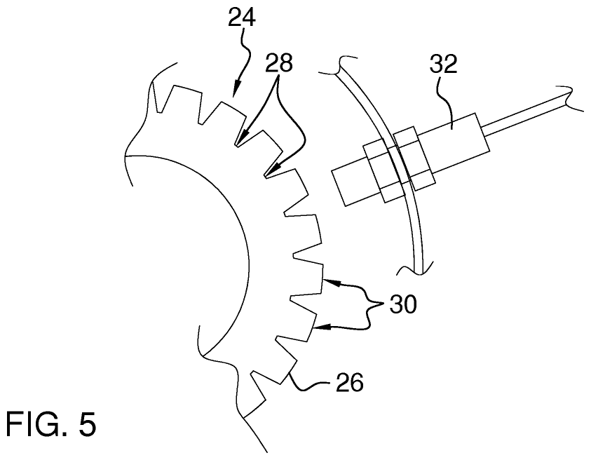

With reference now to the drawings, and in particular to FIGS. 1 through 5 thereof, a new braking device embodying the principles and concepts of an embodiment of the disclosure and generally designated by the reference numeral 10 will be described.

As best illustrated in FIGS. 1 through 5, the trailer braking device 10 generally comprises a trailer 11 that has an axle 12 and a pair of hubs 14 that is each rotatably attached to the axle 12. In this way a pair of wheels 16 can each be removably attached to a respective one of the hubs 14 thereby facilitating the pair of wheels 16 to roll along a support surface 18 when the trailer 11 is being towed. A plurality of wheel brakes 20 is each integrated into a respective one of the hubs 14 and each of the wheel brakes 20 inhibits rotation of the respective hubs 14 when the wheel brakes 20 are actuated thereby braking the trailer 11. Conversely, each of the wheel brakes 20 facilitates the respective hubs 14 to rotate freely when the wheel brakes 20 are not actuated. Each of the wheel brakes 20 comprises an electrically actuated brake which includes but is not limited to drum brakes or disk brakes. Furthermore, the trailer 11 may have a plurality of axles 12 that each has a pair of hubs 14 and a pair of wheels 16 attached to each of the hubs 14.

A pair of wheel speed sensors 22 is provided and each of the wheel speed sensors 22 is integrated into a respective one of the hubs 14 thereby facilitating each of the wheel speed sensors 22 to sense the rotational speed of the respective hub 14. Each of the wheel speed sensors 22 comprises a reluctor ring 24 that is integrated into the hub 14. The reluctor ring 24 has an outer surface 26 which has a series of repeating indentations 28 to define a series of teeth 30 which are evenly spaced apart from each other and are distributed around a full circumference of the outer surface 26. Furthermore, the reluctor ring 24 is oriented in the hub 14 such that the reluctor ring 24 rotates about a rotational axis of the axle 12 and the reluctor ring 24 is comprised of a ferromagnetic material.

Each of the wheel speed sensors 22 includes a magnetic sensor 32 that is attached to the hub 14. The magnetic sensor 32 is aligned with the reluctor ring 24 and the magnetic sensor 32 is triggered each time the magnetic sensor 32 magnetically senses one of the series of teeth 30 on the outer surface 26 of the reluctor ring 24. The magnetic sensor 32 may comprise an electromagnetic sensor, for example, or other type of electronic sensor that employs a magnetic field to remotely sense the teeth 30 on the reluctor ring 24.

A control unit 34 is attached to the trailer 11 and the control unit 34 is in communication with each of the wheel brakes 20 and each of the wheel speed sensors 22. The control unit 34 actuates each of the wheel brakes 20 when the wheel speed sensor 22 associated with the respective wheel brake 20 communicates that a rotational speed of the hub 14 associated with each of the wheel brakes 20 has begun to oscillate with respect to each other. In this way the trailer 11 is inhibited from beginning to sway while the trailer 11 is being towed. Thus, the control unit 34 inhibits a catastrophic accident on a roadway while the trailer 11 is being towed by the tow vehicle 36 which can commonly result from uncontrolled trailer 11 sway.

The control unit 34 comprises a housing 38 that is attached to a frame 40 of the trailer 11 and a control circuit 42 that is positioned within the housing 38. The control circuit 42 receives a brake input and the control circuit 42 includes a processor 44, a signal analyzer 46 and an electronic clock 48. The control unit 34 includes an input cable 50 that is coupled to and extends away from the housing 38 and the input cable 50 comprises a plurality of electrical conductors. The input cable 50 is electrically coupled to the control circuit 42 and the input cable 50 is attachable to an electrical connection 52 on the tow vehicle 36 such that the control circuit 42 is in electrical communication with a power source 54 comprising an electrical system of the tow vehicle 36. The electrical connection 52 on the tow vehicle 36 may comprise a trailer light plug, for example, or other type of electrical connection that is commonly associated with towing a trailer.

The control unit 34 includes a plurality of brake cables 56 and each of the plurality of brake cables 56 comprises a plurality of electrical conductors. Each of the brake cables 56 is coupled between the housing 38 and a respective one of the wheel brakes 20 such that each of the wheel brakes 20 is in electrical communication with the control circuit 42. The control unit 34 includes a plurality of sensor cables 58 and each of the plurality of sensor cables 58 comprises an electrical conductor. Each of the plurality of sensor cables 58 is coupled between the magnetic sensor 32 associated with a respective one of the wheel speed sensors 22 and the housing 38 such that the magnetic sensor 32 associated with the respective wheel speed sensor 22 is electrically coupled to the control circuit 42. The input cable 50 may facilitate a warning system in the tow vehicle 36 to alert the driver that the trailer 11 has begun to sway to facilitate the driver to take corrective action.

The signal analyzer 46 analyzes wheel speed data received from each of the pair of wheel speed sensors 22. The control circuit 42 receives the brake input when the signal analyzer 46 determines that the respective wheel speed sensor 22 is communicating that a rotational speed of the hub 14 associated with a respective wheel speed sensor 22 has exceeded the speed of an opposing hub 14 at least two times over the course of less than three seconds. Additionally, the control circuit 42 actuates each of the wheel brakes 20 when the control circuit 42 receives the brake input. In this way the wheel brakes 20 inhibit the trailer 11 from developing a sway while being towed. Furthermore, the signal analyzer 46 facilitates the trailer 11 to negotiate a corner or a curve without actuating the wheel brakes 20 since the difference in rotation speed between the pair of hubs 14 would be continuous while the trailer 11 is turning rather than oscillating as it would be while the trailer 11 is swaying.

In use, trailers that are improperly loaded can often begin to sway when they are towed at speeds greater than 35.0 miles per hour. Furthermore, the sway almost always results in a catastrophic crash of both the trailer and the tow vehicle. The control unit 34 actuates each of the wheel brakes 20 when the wheel speed sensors 22 sense that the rotational speed of the wheels 16 begins to oscillate, indicating that the trailer 11 has begun to sway. The wheel brakes 20 may be rapidly actuated and de-actuated in accordance with calculations performed by the signal analyzer 46 to best counter act the sway. In this way the wheel brakes 20 counter act the sway in order to keep the trailer 11 under control thereby facilitating a driver of the tow vehicle 36 to safely bring the tow vehicle 36 and the trailer 11 to a stop. Furthermore, the wheel brakes 20 operate independently of the braking system of the tow vehicle 36 and are only actuated when the trailer 11 begins to sway.

With respect to the above description then, it is to be realized that the optimum dimensional relationships for the parts of an embodiment enabled by the disclosure, to include variations in size, materials, shape, form, function and manner of operation, device and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A trailer braking device that is actuated when a trailer begins to sway for stabilizing the trailer, said device comprising:
a trailer having an axle and a pair of hubs each being rotatably attached to said axle thereby facilitating a pair of wheels to each be removably attached to a respective one of said hubs wherein said pair of wheels is configured to roll along a support surface when said trailer is being towed;
a plurality of wheel brakes, each of said wheel brakes being integrated into a respective one of said hubs, each of said wheel brakes inhibiting rotation of said respective hubs when said wheel brakes are actuated thereby braking said trailer, each of said wheel brakes facilitating said respective hubs to rotate freely when said wheel brakes are not actuated;
a pair of wheel speed sensors, each of said wheel speed sensors being integrated into a respective one of said hubs thereby facilitating each of said wheel speed sensors to sense the rotational speed of said respective hub; and
a control unit being attached to said trailer, said control unit being in communication with each of said wheel brakes, said control unit being in communication with each of said wheel speed sensors, said control unit actuating each of said wheel brakes when said wheel speed sensor associated with a respective wheel brake communicates that a rotational speed of said hub associated with each of said wheel brakes has begun to oscillate with respect to each other thereby inhibiting said trailer from beginning to sway while being towed wherein said control unit is configured to inhibit a catastrophic accident on a roadway while said trailer is being towed by the tow vehicle.

2. The device according to claim 1, wherein each of said wheel speed sensors comprises a reluctor ring being integrated into said hub, said reluctor ring having an outer surface which has a series of repeating indentations to define a series of teeth being evenly spaced apart from each other and being distributed around a full circumference of said outer surface, said reluctor ring being oriented in said hub such that said reluctor ring rotates about a rotational axis of said axle, said reluctor ring being comprised of a ferromagnetic material.

3. The device according to claim 2, wherein each of said wheel speed sensors includes a magnetic sensor being attached to said hub, said magnetic sensor being aligned with said reluctor ring, said magnetic sensor being triggered each time said magnetic sensor magnetically senses one of said series of teeth on said outer surface of said reluctor ring.

4. The device according to claim 1, wherein said control unit comprises:
a housing being attached to a frame of said trailer;
a control circuit being positioned within said housing, said control circuit receiving a brake input, said control circuit including a processor and a signal analyzer and an electronic clock; and
an input cable being coupled to and extending away from said housing, said input cable comprising a plurality of electrical conductors, said input cable being electrically coupled to said control circuit, said input cable being attachable to an electrical connection on the tow vehicle such that said control circuit is in electrical communication with a power source comprising an electrical system of the tow vehicle.

5. The device according to claim 4, wherein said control unit includes a plurality of brake cables, each of said plurality of brake cables comprising a plurality of electrical conductors, each of said brake cables being coupled between said housing and a respective one of said wheel brakes such that each of said wheel brakes is in electrical communication with said control circuit.

6. The device according to claim 4, wherein:
each of said wheel speed sensors includes a magnetic sensor; and
said control unit includes a plurality of sensor cables, each of said plurality of sensor cables comprising an electrical conductor, each of said plurality of sensor cables being coupled between said magnetic sensor associated with a respective one of said wheel speed sensors and said housing such that said magnetic sensor associated with said respective wheel speed sensor is electrically coupled to said control circuit.

7. The device according to claim 4, wherein said signal analyzer analyzes wheel speed data received from each of said pair of wheel speed sensors, said control circuit said receiving said brake input when said signal analyzer determines that a respective wheel speed sensor is communicating that a rotational speed of said hub associated with said respective wheel speed sensor has exceeded the speed of an opposing hub at least two times over the course of less than three seconds, said control circuit actuating each of said wheel brakes when said control circuit receives said brake input thereby inhibiting said trailer from developing a sway while being towed.

8. A trailer braking device that is actuated when a trailer begins to sway for stabilizing the trailer, said device comprising:
a trailer having an axle and a pair of hubs each being rotatably attached to said axle thereby facilitating a pair of wheels to each be removably attached to a respective one of said hubs wherein said pair of wheels is configured to roll along a support surface when said trailer is being towed;
a plurality of wheel brakes, each of said wheel brakes being integrated into a respective one of said hubs, each of said wheel brakes inhibiting rotation of said respective hubs when said wheel brakes are actuated thereby braking said trailer, each of said wheel brakes facilitating said respective hubs to rotate freely when said wheel brakes are not actuated;
a pair of wheel speed sensors, each of said wheel speed sensors being integrated into a respective one of said hubs thereby facilitating each of said wheel speed sensors to sense the rotational speed of said respective hub, each of said wheel speed sensors comprising:
a reluctor ring being integrated into said hub, said reluctor ring having an outer surface which has a series of repeating indentations to define a series of teeth being evenly spaced apart from each other and being distributed around a full circumference of said outer surface, said reluctor ring being oriented in said hub such that said reluctor ring rotates about a rotational axis of said axle, said reluctor ring being comprised of a ferromagnetic material; and
a magnetic sensor being attached to said hub, said magnetic sensor being aligned with said reluctor ring, said magnetic sensor being triggered each time said magnetic sensor magnetically senses one of said series of teeth on said outer surface of said reluctor ring; and
a control unit being attached to said trailer, said control unit being in communication with each of said wheel brakes, said control unit being in communication with each of said wheel speed sensors, said control unit actuating each of said wheel brakes when said wheel speed sensor associated with a respective wheel brake communicates that a rotational speed of said hub associated with each of said wheel brakes has begun to oscillate with respect to each other thereby inhibiting said trailer from beginning to sway while being towed wherein said control unit is configured to inhibit a catastrophic accident on a roadway while said trailer is being towed by the tow vehicle, said control unit comprising:
a housing being attached to a frame of said trailer;
a control circuit being positioned within said housing, said control circuit receiving a brake input, said control circuit including a processor and a signal analyzer and an electronic clock;
an input cable being coupled to and extending away from said housing, said input cable comprising a plurality of electrical conductors, said input cable being electrically coupled to said control circuit, said input cable being attachable to an electrical connection on the tow vehicle such that said control circuit is in electrical communication with a power source comprising an electrical system of the tow vehicle;
a plurality of brake cables, each of said plurality of brake cables comprising a plurality of electrical conductors, each of said brake cables being coupled between said housing and a respective one of said wheel brakes such that each of said wheel brakes is in electrical communication with said control circuit; and
a plurality of sensor cables, each of said plurality of sensor cables comprising an electrical conductor, each of said plurality of sensor cables being coupled between said magnetic sensor associated with a respective one of said wheel speed sensors and said housing such that said magnetic sensor associated with said respective wheel speed sensor is electrically coupled to said control circuit, said signal analyzer analyzing wheel speed data received from each of said pair of wheel speed sensors, said control circuit said receiving said brake input when said signal analyzer determines that a respective wheel speed sensor is communicating that a rotational speed of said hub associated with said respective wheel speed sensor has exceeded the speed of an opposing hub at least two times over the course of less than three seconds, said control circuit actuating said each of said wheel brakes when said control circuit receives said brake input thereby inhibiting said trailer from developing a sway while being towed.
